(19) United States
(12) Patent Application Publication
(10) Pub. No.: US 2005/0143208 A1
(43) Pub. Date: Jun. 30, 2005

(54) Pulley

(76) Inventors: Atsushi Ozawa, Sawa-gun (JP); Hidenao Takahashi, Sawa-gun (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/020,266

(22) Filed: Dec. 27, 2004

(30) Foreign Application Priority Data
Dec. 25, 2003 (JP) 2003/430901

(51) Int. Cl. F16H 59/00; F16H 63/00; F16H 55/36

(52) U.S. Cl. 474/166; 474/74

(57) ABSTRACT

The invention provides a pulley that can prevent the rusting of an insertion member without using expensive heat resistant plating treatment and effectively prevent the slippage between a pulley main body and an insertion member. That is, the pulley main body 10a is integrally formed by the injection molding of synthetic resin on the outer circumferential surface side of the insertion member 11b in which painting having rust preventive properties and heat resistant properties is applied to at least part of surfaces including the outer circumferential surface. Therefore, the rusting of the insertion member 11b can be effectively prevented and besides even when the interior of a mold during injection molding comes to a high temperature state, the painting applied to the surface of the insertion member 11b will not deteriorate due to the high temperature and the corrosion resistance of the insertion member 11b will not be decreased. Accordingly, the insertion member 11b can be subjected to rust preventive treatment by relatively inexpensive painting without using expensive heat resistant plating and hence a decrease in manufacturing cost can be achieved.

### BACKGROUND OF THE INVENTION

(i) Field of the Invention

The present invention relates to a pulley that is used, for example, in a compressor of an air conditioning system for vehicles.

(ii) Description of the Related Art

In general, as a compressor that is used in an air-conditioning system for vehicles, there has been known a compressor that comprises a compressor main body formed in a hollow condition, a compression section that compresses a fluid sucked into the compressor main body, a drive shaft connected to the compression section, and a pulley that rotates the drive shaft, and transmits the power of an engine to the pulley by use of a belt wound around the pulley thereby to rotate the drive shaft, drive the compression section and perform the suction and discharge of a cooling medium (for example, in the Japanese Patent Publication 2003-269489).

As a pulley that is used in the above-described compressor, there has been known a pulley that comprises an annular pulley main body formed of synthetic resin and an annular insertion member made of metal into which a bearing is inserted, in which the pulley main body and the insertion member are integrally formed by what is called insert molding that involves injecting synthetic resin by disposing the insertion member in a mold and molding the pulley main body on the side of an outer circumferential surface of the insertion member (for example, refer to the Japanese Patent Publication 2001-227620).

Incidentally, in the above-described pulley, to prevent the insertion member from becoming rusty, the pulley main body is injection molded on the side of an outer circumferential surface of the insertion member after subjecting the surface of the insertion member to plating as rust preventive treatment. When injection molding is performed by use of phenol resin, for example, the temperature in the mold during molding becomes a high temperature of about 180° C. and further becomes also a high temperature of about 200° C. in size stabilizing treatment (baking) after molding. For this reason, highly heat resistant plating, such as hard chromium plating and nickel plating, has hitherto been adopted for the plating of the insertion member. However, such heat resistant plating is expensive compared to general plating, posing the problem that the plating increases the manufacturing cost of products.

Furthermore, because the adhesion between the insertion member the surface of which is plated and the pulley made of resin is not high, this has posed the problem that the interface between the insertion member and the pulley main body is apt to cause slippage.

### SUMMARY OF THE INVENTION

In view of the above-described problems, the object of the present invention is to provide a pulley that can prevent the rusting of an insertion member without using expensive heat resistant plating and can effectively prevent the slippage of an interface surface between a pulley main body and the insertion member.

To achieve the above-described object, in the invention there is provided a pulley that comprises an annular pulley main body made of synthetic resin and an annular insertion member made of metal into which a bearing is inserted, and in this pulley, the pulley main body and the insertion member are integrally formed by injection molding the pulley main body on the side of an outer circumferential surface of the insertion member. In this pulley, painting having rust preventive properties and heat resistant properties is applied to at least part of a surface including an outer circumferential surface of the insertion member and the pulley main body is formed on the side of the outer circumferential surface of the insertion member.

As a result of this, the rusting of the insertion member is prevented by the painting applied to the surface of the insertion member and, at the same time, even when the interior of a mold during the injection molding of the pulley main body and the like comes to a high temperature state, the painting applied to the surface of the insertion member will not deteriorate due to the high temperature. Therefore, the insertion member can be subjected to rust preventive treatment by relatively inexpensive painting without using expensive heat resistant plating and hence a decrease in manufacturing cost can be achieved.

### BRIEF DESCRIPTION OF THE DRAWINGS

FIG. 1 is a side sectional view of an embodiment of a power transmission device that uses a pulley of the invention;

FIG. 2 is a sectional view taken along the line A-A of FIG. 1;

FIG. 3 is a partial side sectional view of a power transmission device;

FIG. 4 is a side sectional view that shows operation during a power shutoff;

FIG. 5 is a perspective view of an insertion member;

FIG. 6 is a partial side sectional view of an insertion member;

FIG. 7 is a partial side sectional view that shows a manufacturing process of a pulley;

FIG. 8 is a partial side sectional view that shows a manufacturing process of a pulley;

FIG. 9 is a partial side sectional view of a pulley main body and an insertion member; and

FIG. 10 is a partial side sectional view that shows a modification of this embodiment.

### DESCRIPTION OF THE PREFERRED EMBODIMENTS

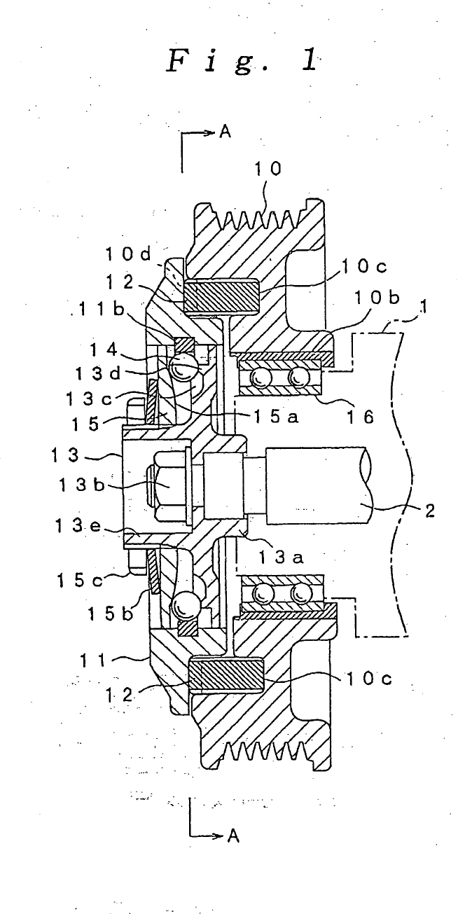

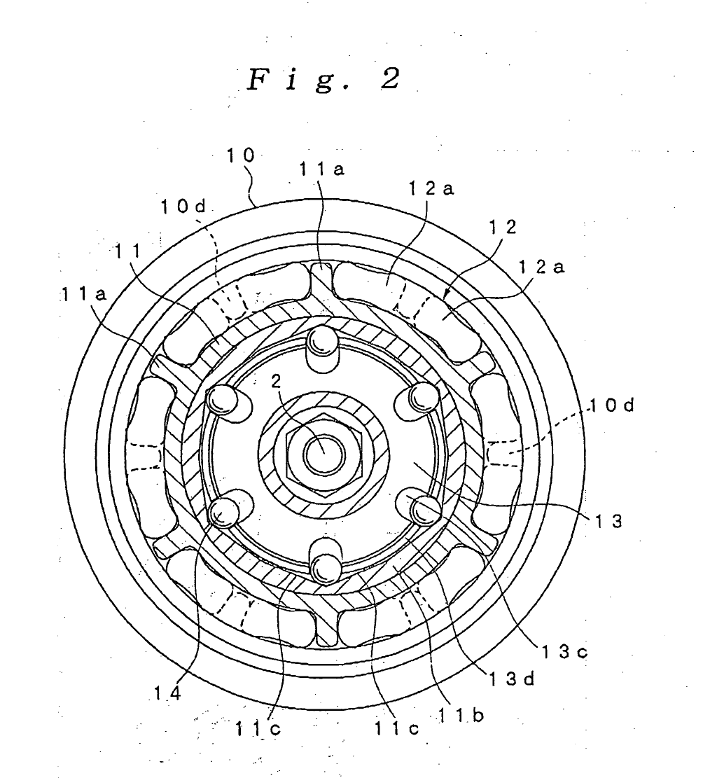

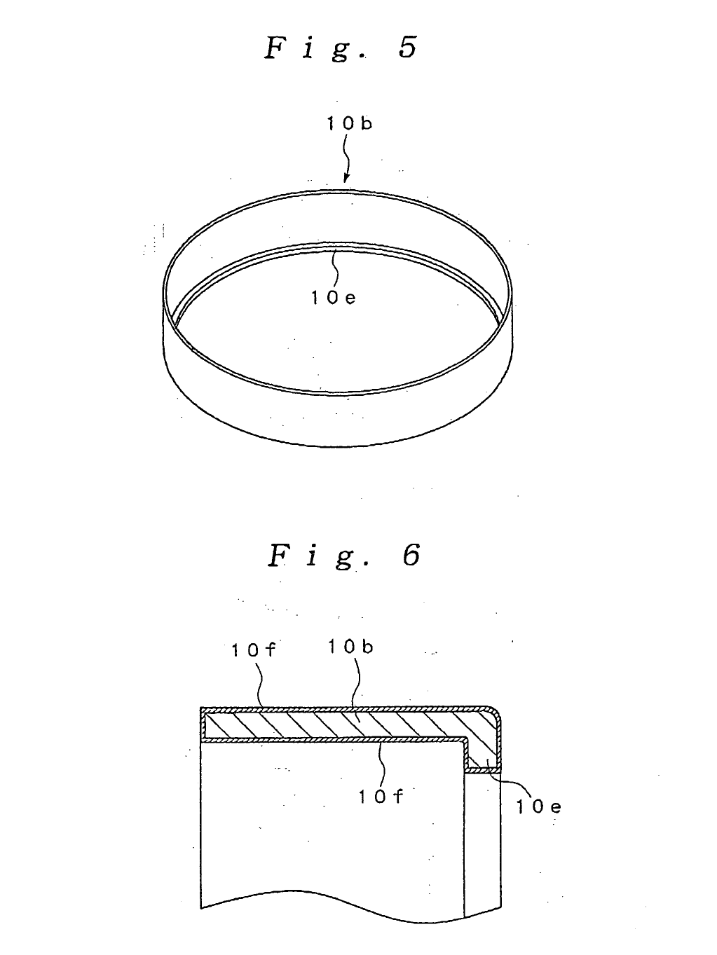

The power transmission device shown in FIG. 1 to FIG. 9 is used in an air-conditioning system for vehicles and transmits power to a drive shaft 2 that protrudes from one end of a compressor main body 1.

That is, the power transmission device of the invention comprises a pulley 10 to which powder from outside is transmitted, a transmission ring 11 that is rotated by the power transmitted to the pulley 10, multiple cushion rubbers 12 that transmit a torque of the pulley 10 to the transmission ring 11, a hub 13 connected to the drive shaft 2, multiple balls 14 that transmit the torque of the transmission ring 11 to the hub 13, and ball depressing ring 15 that axially depresses each of the balls 14.

The pulley comprises an annular pulley main body 10a formed of synthetic resin and an annular insertion member 10b that is provided on the side of an inner circumferential surface of the pulley main body 10a and into which a bearing 16 is inserted, and the pulley main body 10a is constructed so that a V-belt not shown in the drawing can be wound around an outer circumferential surface thereof. An end face of the pulley main body 10a is provided with an annular groove part 10c that extends circumferentially, and within the groove part 10c there are provided multiple protrusions 10d that are circumferentially space from each other and protrude axially. The insertion member 10b is formed from a cylindrical metal member, and a flange 10e that bends to the radial inside is provided on an axial end of the insertion member 10c.

The transmission ring 11 is disposed so that an end thereof is opposed to an end face of the pulley 10 and the surface opposed to the pulley 10 is provided with multiple protrusions 11a that are circumferentially spaced from each other and protrude axially. Each of the protrusions 11a is inserted into the groove part 10c of the pulley 10, and the protrusions 11a and the protrusions 10d of the pulley 10 are alternately disposed in the circumferential direction. The protrusions 11a are circumferentially spaced from the protrusions 10d of the pulley 10 and opposite thereto. A locking ring 11b that engages and locks with each of the balls 14 from the radial outside is attached to the inner circumferential surface of the transmission ring 11. Multiple tapered surfaces 11c that form a prescribed angle with each other are formed on an inner circumferential surface of the locking ring 11b, and each of the balls 14 abuts against one of the tapered surfaces 11c that are adjacent to each other so as to be positioned radially outside.

Each of the cushion rubbers 12 is formed in block shape and disposed between the protrusion 10d of the pulley 10 and the protrusion 11a of the transmission ring 11. Each of the cushion rubbers 12 is constituted by a pair of cushion parts 12a, which are disposed each on both sides of the protrusion 10d of the pulley 10 in the circumferential direction, and each of the cushion parts 12a are formed with a width substantially equal to the groove part 10c of the pulley 10 so as to bend along the groove part 10c.

The hub 13 is formed in disk shape and disposed on the inner circumferential surface side of the transmission ring 11. On one end face side of the hub 13, a connecting part 13a that connects the drive shaft 2 is provided, and the drive shaft 2 is fixed to the hub 13 by a nut 13b that screws the drive shaft 2 from the other end face of the hub 13. Multiple ball grooves 13c that engage with each of the balls 14 to move them respectively radially are circumferentially spaced from each other on the other end face of the hub 13, and each of the balls 14 is circumferentially locked on the inner surface side of the ball grooves 13c. In this case, a convexity 13d that protrudes axially is provided on the radial outside of each of the ball grooves 13c, and the convexity 13d abuts axially against the ball 14 positioned on the radial outside of the ball groove 13c. In the radial middle of the other end face of the hub 13, an extending part 13e that extends axially in cylindrical form is provided so as to cover the nut 13b.

The balls 14 are spaced from each other in the circumferential direction of the hub 13, and each of the balls 14 is disposed within each of the ball groves 13c of the hub 13.

The ball depressing ring 15 is axially movably engages with the extending part 13e of the hub 13 and one end side of the ball depressing ring 15 abuts against each of the balls 14. An inclined surface 15a that protrudes axially gradually from the axial outside toward the inside is provided on one end face of the ball depressing ring 15, and the ball 14 positioned on the radial outside of each of the ball grooves 13c abuts against the radial outside of the inclined surface 15a. A coned disc spring 15b that engages with the extending part 13e of the hub 13 is provided on the other end face side of the ball depressing ring 15, and the ball depressing ring 15 is urged to the ball 14 side by the coned disc spring 15b. The coned disc spring 15b is disposed in a compressed condition between an annular nut 15c that is screwed to the extending part 13e and it is possible to arbitrarily set a depressing force of the ball depressing ring 15 by the coned disc spring 15b by adjusting the fastening force of the nut 15c.

In the power transmission device constructed as described above, the transmission ring 11 rotates integrally with the pulley 10 when the power from an engine is input to the pulley 10. On that occasion, the torque of the pulley 10 is transmitted to the transmission ring 11 via each of the cushion rubbers 12, and each of the cushion rubbers 12 is elastically deformed between the concavity 10d of the pulley 10 and the concavity 11a of the transmission ring 11, with the result that impacts by abrupt torque changes etc. are absorbed. The torque of the transmission ring 11 is transmitted to the hub 13 via the locking ring 11b and each of the balls 14 and the drive shaft 2 rotates along with the hub 13. On that occasion, each of the balls 14 is depressed to the radial outside of each of the ball grooves 13c by the inclined surface 15a of the ball depressing ring 15, and the torque of the transmission ring 11b is transmitted to the hub 13 by the circumferential engagement and locking of each of the balls 14 with the tapered surface 11c of the locking ring 11b.

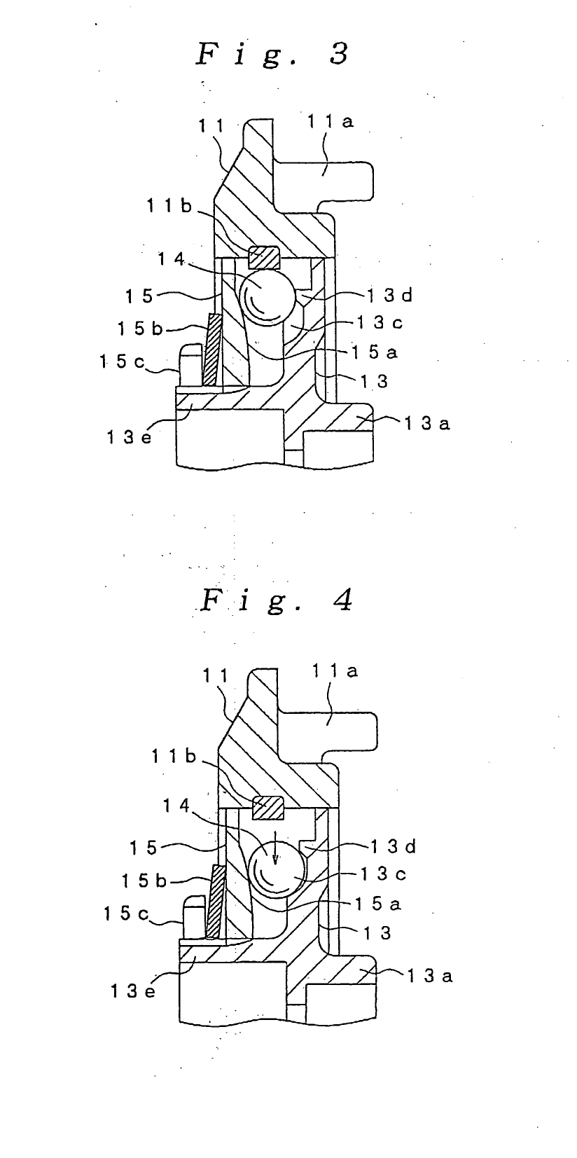

If an excessive rotation load is applied to the pulley 10 side, for example, by the burn-out and sticking of a compressor, due to the depressing of the tapered surface 11c of the locking ring 11b, as shown in FIG. 3, each of the balls 14 moves to the radial inside of the ball groove 13c against the depressing force of the ball depressing ring 15. As a result of this, each of the balls 14 is held on the radial inside of the ball groove 13c by the convexity 13d of the ball groove 13c and the ball depressing ring 15 and each of the balls 14 is under constraint in a position incapable of engagement and locking with the locking ring 11b. Therefore, the transmission ring 11 becomes idle with respect to the hub 13 and hence the transmission of power from the pulley 10 side to the drive shaft 2 is shut off.

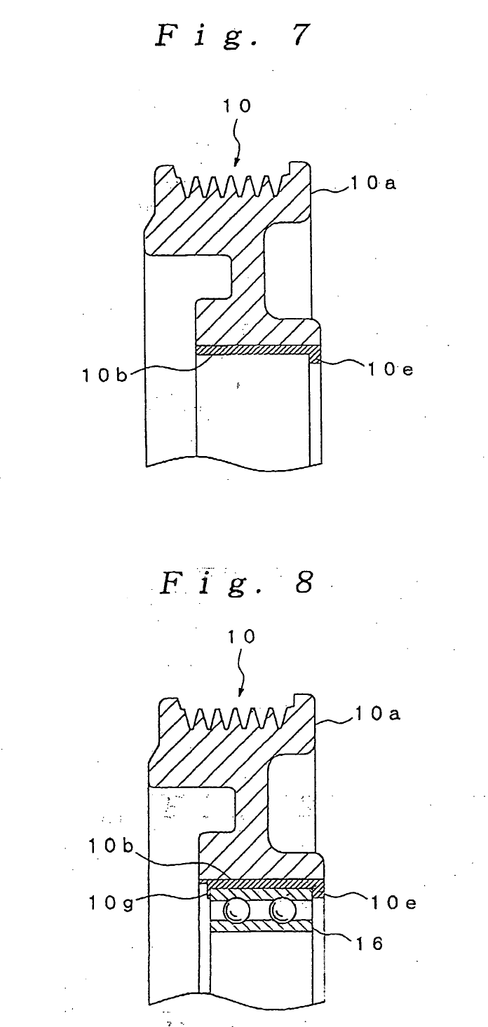

In making the above-described pulley 10, after the application of painting having rust preventive properties and heat resistant properties to the whole surface of the insertion member 10b, the insertion member 10b is disposed within a mold for injection molding (not shown) and synthetic resin such as phenol resin is injected into the mold, whereby as shown in FIG. 7, the pulley main body 10a is integrally formed on the outer circumferential surface side of the insertion member 10b. In this case, a paint film 10f applied to the insertion member 10b is formed in such a manner that the break strength of the paint film 10f itself is smaller than the adhesive strength between the pulley main body 10a and the insertion member 10b. When the above-described paint film 10f is formed, for example, epoxy resin painting, acrylic resin painting or cationic electrodeposition painting is preferable.

The bearing 16 is inserted into the pulley 10 formed as described above from the other end side of the insertion member 10b in the axial direction and, as shown in Fig. 8, the other end portion of the insertion member 10b in the axial direction is caused to protrude to the axial inside by caulking, whereby the bearing 16 is held between this caulked part 10g and the flange 10e.

Thus, according to the pulley of this embodiment, the pulley main body 10a is integrally formed by the injection molding of synthetic resin on the outer circumferential surface side of the insertion member 10b in which painting having rust preventive properties and heat resistant properties is applied to at least part of surfaces including the outer circumferential surface. Therefore, the rusting of the insertion member 10b can be effectively prevented and besides even when the interior of a mold during injection molding comes to a high temperature state, the painting applied to the surface of the insertion member 10b will not deteriorate due to the high temperature and the corrosion resistance of the insertion member 11b will not be decreased. Accordingly, the insertion member 10b can be subjected to rust preventive treatment by relatively inexpensive painting without using expensive heat resistant plating and hence a decrease in manufacturing cost can be achieved.

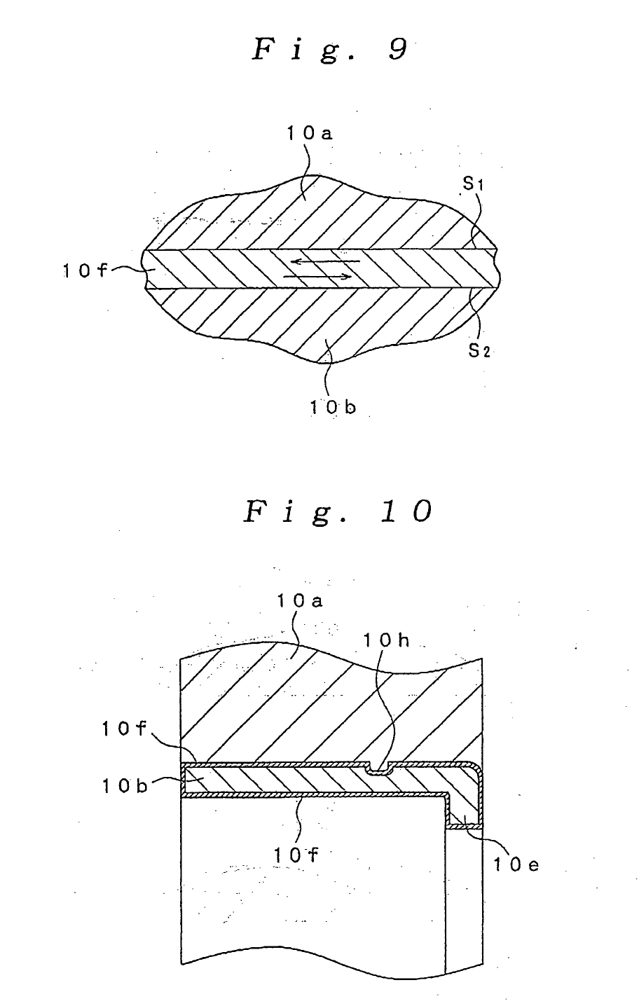

The paint film 10f applied to the insertion member 10b is formed in such a manner that the break strength of the paint film 10f itself is smaller than the adhesive strength between the pulley main body 10a and the insertion member 10b. Therefore, as shown in FIG. 9, before the exfoliation of an interface S1 between the pulley main body 10a and the paint film 10f or an interface S2 between the insertion member 10b and the paint film 10f, owing to the elasticity of the paint film 10f it is possible to absorb shearing forces in the slip directions of the pulley main body 10a and the insertion member 10b as shown in the solid-line arrows in the figure, and the slippage between the paint film 10f and the pulley main body 10a or between the paint film 10f and the insertion member 10b can be effectively prevented.

In the above-described embodiment, the slippage between the pulley main body 10a and the insertion member 10b is prevented by the elasticity of the paint film 10f. As shown in FIG. 10, however, the outer circumferential surface of the insertion member 10b may be provided with a concavity 10h as an engaging part that engages with the inner circumferential surface of the pulley main body 10a to ensure that the slippage between the pulley main body 10a and the insertion member 10b is prevented by the engagement of the concavity 10h with the pulley main body 10a. Incidentally, the engaging is not limited to the concavity 10h. For example, the insertion member 10b may be provided with a convexity or an engaging part of another shape may be provided.

Incidentally, although in the above-described embodiments, a pulley used in the power transmission device of a compressor was described, the invention can be applied to a pulley used in other rotary devices.

1. A pulley comprising:
an annular pulley main body made of synthetic resin and an annular insertion member made of metal into which a bearing is inserted, in which the pulley main body and the insertion member are integrally formed by injection molding the pulley main body on the side of an outer circumferential surface of the insertion member,
wherein painting having rust preventive properties and heat resistant properties is applied to at least part of surfaces including the outer circumferential surface of said insertion member and the pulley main body is formed on the side of the outer circumferential surface of the insertion member.

2. The pulley according to claim 1, wherein a paint film applied to said insertion member is formed in such a manner that the break strength of the paint film itself is less than the adhesive strength between the pulley main body and the insertion member.

3. The pulley according to claim 1, wherein epoxy resin painting is used as the painting applied to said insertion member.

4. he pulley according to claim 1, wherein acrylic resin painting is used as the painting applied to said insertion member.

5. The pulley according to claim 1, wherein electrodeposition painting is used as the painting applied to said insertion member.

6. The pulley according to claim 1, wherein an engaging part that engages with an inner circumferential surface of the pulley main body is provided on the outer circumferential surface of said insertion member.

7. The pulley according to claim 6, wherein said engaging part is formed by a concavity or a convexity provided on the outer circumferential surface of the insertion member.

8. The pulley according to claim 2, wherein epoxy resin painting is used as the painting applied to said insertion member.

9. The pulley according to claim 2, wherein acrylic resin painting is used as the painting applied to said insertion member.

10. The pulley according to claim 2, wherein electrodeposition painting is used as the painting applied to said insertion member.

11. The pulley according to claim 2, wherein an engaging part that engages with an inner circumferential surface of the pulley main body is provided on the outer circumferential surface of said insertion member.

12. The pulley according to claim 11, wherein said engaging part is formed by a concavity or a convexity provided on the outer circumferential surface of the insertion member.
